(19) United States
(12) Patent Application Publication
(10) Pub. No.: US 2009/0226646 A1
(43) Pub. Date: Sep. 10, 2009

(54) GLASS PARTICLES WITH SMOOTHED SURFACES FOR USE AS ARTIFICIAL TURF FILL

(75) Inventors: David A. Dlubak, Upper Sandusky, OH (US); Aaron L. Teel, State College, PA (US); Rodney D. Allebach, State College, PA (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Viceroy Ceramics, Upper Sandusky, OH (US)

(21) Appl. No.: 12/396,510

(22) Filed: Mar. 3, 2009

Related U.S. Application Data
(60) Provisional application No. 61/068,323, filed on Mar. 6, 2008.

(51) Int. Cl. E01C 13/08; A41G 1/00; C03B 19/10

(52) U.S. Cl. 428/17; 428/402; 264/15

(57) ABSTRACT

A fill, infill or propant material used in an artificial turf application includes glass particles having an irregular shape and smoothed surfaces. An artificial turf includes: a base; a carpet of synthetic grass fibers on the base; and a fill material dispersed between and supporting the fibers; the fill material including glass particles having an irregular shape and smoothed surfaces. A method of producing a fill material for use in an artificial turf includes: providing glass particles having an irregular shape and sharp surfaces; and smoothing the surfaces of the particles through a chemical, mechanical or thermal process or a combination of these processes.

### CROSS-REFERENCE TO RELATED APPLICATIONS

This application claims the benefit of U.S. Provisional Application No. 61/068,323, filed Mar. 6, 2008, the disclosure of which is incorporated herein by reference.

### BACKGROUND OF THE INVENTION

Artificial turf or synthetic turf surfaces have gained wide acceptance as playing fields for multiple sporting activities as well as use in commercial and home landscaping and architectural settings. These grass replacement surfaces require less maintenance, use less water and can support a higher number of events than a traditional grass field.

As shown in FIG. 1, a typical artificial turf field 10 is composed of a sub base 12, a padding layer 14, a synthetic turf carpet (including synthetic grass fibers 16 attached to a backing layer 18) and fill 20 to support the fibers 16. The sub base 12 is typically a stone, gravel or sand layer put in place to provide a stable surface that will support the turf and allow proper drainage. Various types of padding 14 may or may not be used, depending on the application, to provide a cushion or shock absorbing layer. The synthetic turf carpet 16 and 18 is then put into place. Fill 20 or sometimes called infill or propant is then raked into the turf surface to support the synthetic grass fibers 16 to a depth that will support the fibers. The depth of fill 20 is dependent on the tightness of the fiber weave, the length of fibers, the type of fibers and intended field use. In the past, this fill has predominantly been composed of synthetic crumb or ground rubber. To a lesser extent, some naturally occurring sand, cork, synthetic polymer foams or combinations of these have been used.

Current fill practices are undergoing scrutiny due to hazardous chemical leeching, hazardous chemical exposure, current and future waste disposal limitations and/or restriction, and biological hazard retention and growth.

### SUMMARY OF THE INVENTION

This invention relates to a fill, infill or propant material used in an artificial turf application comprising glass particles having an irregular shape and smoothed surfaces.

The invention also relates to an artificial turf comprising: a base; a carpet of synthetic grass fibers on the base; and a fill material dispersed between and supporting the fibers; the fill material comprising glass particles having an irregular shape and smoothed surfaces.

The invention further relates to a method of producing a fill material for use in an artificial turf comprising: providing glass particles having an irregular shape and sharp surfaces; and smoothing the surfaces of the particles through a chemical, mechanical or thermal process or a combination of these processes.

Various aspects of this invention will become apparent to those skilled in the art from the following detailed description of the preferred embodiment, when read in light of the accompanying drawings.

### BRIEF DESCRIPTION OF THE DRAWING

FIG. 1 is an enlarged cross-sectional view of a typical artificial turf field.

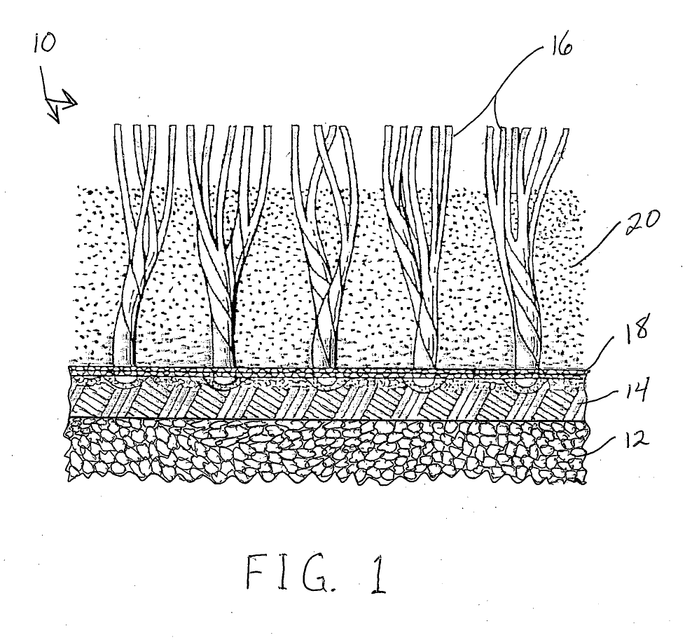

### DETAILED DESCRIPTION OF THE PREFERRED EMBODIMENT

This invention relates to a fill, infill or propant material used in an artificial turf application comprising glass particles having an irregular shape and smoothed surfaces.

The glass particles can be made from any type of glass. Some examples of silica-based glasses include soda-lime silicates (combinations of Na₂O, CaO and SiO₂), aluminosilicates (combinations of Al₂O₃ and SiO₂), lime-silicates (combinations of CaO and SiO₂), and sodium aluminosilicates (combinations of Na₂O, Al₂O₃ and SiO₂). Some examples of non-silica based glasses include vitreous metal and non-metal oxide systems, including P₂O₅, GeO₂, B₂O₃, Al₂O3, Li₂O, Na₂O, K₂O, BeO, MgO, CaO, BaO, PbO, ZnO and FeO, flint glasses, crown glasses, borate glasses, phosphate glasses, calcium aluminate glasses, and calcium germanate glasses.

In one embodiment, the glass particles are made from glass selected from the soda-lime, aluminosilicate and/or flint families of glasses. In another embodiment, the glass particles are made from glass that is substantially non-metallic. The glass can be substantially amorphous or it can be partially crystalline. The glass can be either recycled glass or virgin glass or a blend of both.

The glass particles have an irregular shape. By “irregular” shape is meant any shape that is not symmetrical. For example, the particles do not have a shape that perfectly round or the like. The irregular shape of the glass particles makes them more suitable for use as a fill in an artificial turf application.

The starting glass particles can be provided by any suitable method, for example, by any mechanical and/or chemical method of producing such particles from glass. In one embodiment, glass is particulated by the use of any suitable crushing, grinding or milling equipment, in either a wet or dry operation. For example, a hammer mill can be suitable for making the starting glass particles.

The starting glass particles and/or the product glass particles can be screened or classified to obtain a desired size for use as a fill material in an artificial turf application. The product glass particles can have any size suitable for use as fill material. In some embodiments, they have a median particle size within a range of from about ⅜″ mesh to about 200 mesh, particularly from about 4 mesh to about 80 mesh, and more particularly from about 8 mesh to about 20 mesh. The size of the starting glass particles can be different from or the same as the product glass particles. In one embodiment, the starting glass particles have a median particle size that is within the desired particle size range for the product particles.

The starting glass particles have sharp surfaces. These surfaces can include sharp edges of the particles, sharp surfaces that are created by sizing the particles, and/or fractures of the particles that create sharp surfaces, or any other type of non-smooth surfaces. The glass particles having sharp surfaces are poorly suited for use as fill in artificial turf applications because they are difficult to handle and they can damage the synthetic turf carpet. To address these problems, the present invention provides glass particles having smoothed surfaces to make them desirable for use in artificial turf applications. The smoothed surfaces can include rounded edges, smoothed fractures, and the like.

The surfaces of the glass particles can be smoothed by any suitable method. For example, the surfaces can be smoothed through a chemical, mechanical or thermal process or any combination of these processes. In one embodiment, the smoothing process includes tumbling the particles in a rotary drum or other suitable tumbling apparatus. Optionally, an anti-stick additive can be added to the particles before the tumbling. Any suitable additive can be used, such as boron nitride, calcium carbide, calcium nitrate, or clay.

In another embodiment, the smoothing process includes melting the sharp surfaces to make them smooth by the use of heat and/or acid. For example, the glass particles can be heated in a furnace to melt the sharp surfaces, or they can be exposed to acid in a bath or spray to melt the sharp edges.

In a particular example, the glass particles are mixed with an anti-stick additive. Then the mixture of particles and additive is tumbled in a rotary drum. Optionally, after tumbling the particles can be treated with any suitable chemical to facilitate the process. Then the particles are put through an acid wash to melt the sharp surfaces of the particles.

In another particular example, the smoothing process includes a combination of tumbling and heating the glass particles, which can be conducted in any order or together. For example, the particles can be simultaneously tumbled and heated to melt the sharp surfaces and also smooth them through a tumbling action.

The product glass particles can have any density suitable for use as a fill material in an artificial turf application. For example, in one embodiment the particles have a bulk density within a range of from about 65 pounds per cubic foot to about 150 pounds per cubic foot. Lower density glass particles may be desirable for use in some applications. For example, the lower density particles tend to absorb less heat than higher density particles and thus they may be desirable for use in higher temperature environments. On the other hand, higher density glass particles tend to produce a more stable fill which locks in the synthetic grass fibers. In some applications it may be desirable to use glass particles that are medium in density, or to use any suitable blend of lower density particles and higher density particles.

Depending on the application, in some embodiments it may be desirable to coat the product glass particles with a coating material. Any suitable coating material can be used, for example, vegetable oil, mineral oil, acrylic polymer, or other polymers. Any suitable coating process can be used, such as a spraying, curtain coating or dipping process. In other embodiments the product glass particles are left uncoated.

The product glass particles may be suitable for use as a fill material in any artificial turf application. For example, some applications for artificial turf include athletic fields and residential and commercial landscaping.

The glass particles may be recyclable at the end of their useful life and may be reused in similar or different applications. The glass particles can be a safe, inert alternative to current fill materials.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A fill, infill or propant material used in an artificial turf application comprising glass particles having an irregular shape and smoothed surfaces.

2. The material of claim 1 wherein the smoothed surfaces include rounded edges.

3. The material of claim 1 wherein the smoothed surfaces include smoothed fractures.

4. The material of claim 1 wherein the glass is substantially amorphous.

5. The material of claim 1 wherein the glass particles have a bulk density within a range of from about 65 pounds per cubic foot to about 150 pounds per cubic foot.

6. The material of claim 1 wherein the glass particles have a median particle size within a range of from about ⅜″ mesh to about 200 mesh.

7. The material of claim 1 wherein the surfaces of the glass particles are smoothed through a chemical, mechanical or thermal process or a combination of these processes.

8. A fill, infill or propant material used in artificial turf applications comprising:
a. inorganic, amorphous glass structure made from recycled and/or virgin glass supply;
b. typically composed of, but not limited to, the soda-lime, aluminosilicate and/or flint families of glasses;
c. sized in accordance to use from ⅜″ to 200 mesh;
d. coated or not coated surfaces;
e. having a bulk density of less than 150 pounds per cubic foot but more than 65 pounds per cubic foot;
f. irregular shaped and having fracture and/or sharp edges rounded through chemical, mechanical and/or thermal processes or combinations of these.

9. An artificial turf comprising:
a base;
a carpet of synthetic grass fibers on the base; and
a fill material dispersed between and supporting the fibers;
the fill material comprising glass particles having an irregular shape and smoothed surfaces.

10. A method of producing a fill material for use in an artificial turf comprising:
providing glass particles having an irregular shape and sharp surfaces; and
smoothing the surfaces of the particles through a chemical, mechanical or thermal process or a combination of these processes.

11. The method of claim 10 wherein the smoothing process includes rounding the edges of the particles and smoothing any fractures of the particles.

12. The method of claim 10 wherein the smoothing process includes tumbling the particles.

13. The method of claim 10 wherein the smoothing process includes melting the sharp surfaces by heat and/or acid.

14. The method of claim 10 wherein the smoothing process includes:
mixing the glass particles with an anti-stick additive; and then
tumbling the mixture of particles and additive; and then
exposing the particles to acid.

15. The method of claim 10 wherein the smoothing process includes:
tumbling and heating the glass particles, the tumbling and heating being conducted in any order or together.

16. The method of claim 10 wherein the glass particles provided before the smoothing process have a median particle size that is within a desired particle size range for the product particles.
